(19) United States
(12) Patent Application Publication
(10) Pub. No.: US 2004/0174635 A1
(43) Pub. Date: Sep. 9, 2004

(54) Magnetic disk cartridge

(75) Inventor: Fumihito Imai, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/792,212

(22) Filed: Mar. 4, 2004

(30) Foreign Application Priority Data
Mar. 6, 2003 (JP) 059921/2003

(51) Int. Cl. G11B 23/03

(52) U.S. Cl. 360/133

(57) ABSTRACT

A magnetic disk cartridge which comprises a housing provided with a shutter lock member, and which facilitates attachment of the shutter lock member and prevents dust or other contaminants from entering via the portion where the shutter lock member is attached.

The shutter lock member is constituted by a shutter lock body having a slide contact surface on the upper surface thereof; a sliding-contact-surface-side protrusion extending from the upper surface; and an opposite-surface-side protrusion extending from the lower surface. The shutter lock member is rotatably disposed between upper and lower shell halves while the sliding contact surface is in sliding contact with the inner surface of the upper shell half with the sliding-contact-surface-side protrusion being rotatably received within a protrusion receiving hole formed in the upper shell half, and while the end of the opposite-surface-side protrusion is in sliding contact with the inner surface of the lower shell half.

### BACKGROUND OF THE INVENTION

1. Field of the Invention

The present invention relates to compact magnetic disk cartridges replaceably held within a card type disk drive that can be inserted into a card slot of an electronic apparatus such as a digital still camera, a digital video camera, a laptop computer or the like.

2. Description of the Related Art

Conventionally, mobile equipment such as a digital camera, etc., uses as recording media very small magnetic disk cartridges called “clik!™” as described in patent literature, e.g. U.S. Pat. No. 6,256,168.

This magnetic disk cartridge comprises a flat housing (width 50 mm, depth 55 mm, thickness 1.95 mm) constituted by a resin frame including a push portion, and upper and lower shell halves formed of thin metal sheets; and a 1.8 inch diameter magnetic disk with a 40 MB storage capacity rotatably accommodated in the flat housing.

This housing of the magnetic disk cartridge has a wedge-shaped opening to allow a magnetic head of a drive unit to access a surface of the magnetic disk, and a rotary shutter used to open and close this opening. The rotary shutter is spring-loaded towards its closing direction by means of a small-diameter elongate coil spring.

In the left end surface of the housing, a notch to be engaged with a latching portion formed within the drive unit is provided to ensure positioning of the cartridge in the drive unit. Meanwhile, in the right end surface of the housing, a small window for exposing a shutter lock member towards the exterior is provided to keep the rotary shutter locked in the closed position.

The lower shell half of the housing includes a circular opening through which a rotary spindle of the drive unit couples with the center core of the magnetic disk, and an arcuate groove concentric with the rotary shutter. The rotary shutter has a shutter knob fixedly provided thereon which projects from the aforementioned arcuate groove and travels along this arcuate groove to allow opening and closing of the rotary shutter.

In the shutter lock member of the aforementioned “clik!”, a cylindrical projection formed on the upper shell half by burring or the like is inserted through a receiving portion formed in the shutter lock member, and then the distal end of the projection is caulked, whereby the shutter lock member is held within the upper shell half so as to be rotatable about the receiving portion. Mounting in this way, however, may cause undesired invasion of dust or other contaminants to the interior of the housing through the hole for the cylindrical projection.

In addition, since the diameter of the aforementioned projection is as small as 1 mm, durability of a punching die used for burring is low, and productivity is poor because great accuracy of caulking is required.

### SUMMARY OF THE INVENTION

In view of the foregoing, an object of the present invention is to provide a magnetic disk cartridge which has a housing provided with a shutter lock member and which overcomes the aforementioned problems.

The magnetic disk cartridge of the invention comprises a flat housing constituted by upper and lower shell halves, and a magnetic disk as a recording medium which is rotatably accommodated within the housing. The housing includes an opening to allow a recording/reproducing head of a drive unit to access a surface of the magnetic disk, a rotary shutter used to open and close the opening, and a shutter lock member for locking the rotary shutter at its closed position. The shutter lock member is constituted by a shutter lock body having a sliding contact surface provided on the upper or lower surface of the shutter lock member in sliding contact with the inner surface of either one of the upper and lower shell halves, a sliding-contact-surface-side protrusion formed on the one of the upper or lower surface of the shutter lock body, and an opposite-surface-side protrusion formed on the other of the upper or lower surface of the shutter lock body. One of the upper and lower shell halves includes a protrusion receiving hole having a diameter substantially the same as that of the sliding-contact-surface-side protrusion. The shutter lock member is rotatably disposed between the upper and lower shell halves while the sliding contact surface of the shutter lock member is in sliding contact with the inner surface of the one of the shell halves with the sliding-contact-surface-side protrusion being rotatably received within the protrusion receiving hole, and while the end of the opposite-surface-side protrusion is in sliding contact with the inner surface of the other shell half.

Each of the shutter lock body, sliding-contact-surface-side protrusion, and opposite-surface-side protrusion may be wholly or partially formed separately from the shutter lock member and later immovably fixed thereto, or all of the shutter lock body, sliding-contact-surface-side protrusion, and opposite-surface-side protrusion may be integrally formed with the shutter lock member.

In the case of integrally forming the shutter lock body by deep drawing or the like, if a recess, which is concave relative to the sliding-contact-surface-side protrusion, is provided at the distal end of the opposite-surface-side protrusion, and a projection, which matingly engages with this recess, is provided on the other shell half, the distance from the distal end of the sliding-contact-surface-side protrusion to the distal end of the opposite-surface-side protrusion can be reduced, which facilitates the deep drawing if it is used.

When this invention is applied to a magnetic disk cartridge of the “clik!™” type, proper construction can be obtained by setting the diameter of the sliding-contact-surface-side protrusion to have a diameter of 2 mm, setting the distance from the sliding contact surface to the distal end of the sliding-contact-surface-side protrusion to be 0.2 mm, and setting the distance from the sliding contact surface to the distal end of the opposite-surface-side protrusion to be 1.55 mm.

Thus, in accordance with the present invention, there is provided a magnetic disk cartridge comprising a housing having a shutter lock member, wherein the shutter lock member is constituted by a shutter lock body having a sliding contact surface provided on the upper or lower surface of the shutter lock member in sliding contact with the inner surface of either one of the upper and lower shell halves, a sliding-contact-surface-side protrusion formed on the one of the upper or lower surface of the shutter lock body, and an opposite-surface-side protrusion formed on the other of the upper or lower surface of the shutter lock body, wherein the housing is configured such that one of the upper and lower shell halves includes a protrusion receiving hole having a diameter substantially the same as that of the sliding-contact-surface-side protrusion, and that the shutter lock member is rotatably disposed between the upper and lower shell halves while the sliding contact surface of the shutter lock member is in sliding contact with the inner surface of the one of the shell halves with the sliding-contact-surface-side protrusion being rotatably received within the protrusion receiving hole and while the end of the opposite-surface-side protrusion is in sliding contact with the inner surface of the other shell half. This eliminates the necessity of burring and caulking which have been conventionally required when attaching the shutter lock member, such that assembly is facilitated and the cylindrical projection in communication with the interior of the housing becomes unnecessary, which can prevent dust or other contaminants from entering via the cylindrical projection.

### BRIEF DESCRIPTION OF THE DRAWINGS

FIG. 1A, FIG. 1B, and FIG. 1C respectively illustrate a plan view, a right side view, and a bottom view of a magnetic disk cartridge according to the present invention;

FIG. 2 is a plan view showing a body of a PC card type drive unit suitable for use with the magnetic disk cartridge of the invention;

FIG. 3 is a perspective view of a shutter lock member of the magnetic disk cartridge shown in FIGS. 1A to 1C;

FIG. 4 is a side view of the shutter lock member shown in FIG. 3;

FIG. 5 is a cross sectional view of a shutter lock member attaching portion of a housing of the magnetic disk cartridge; and

FIGS. 6A and 6B illustrate cross sectional views of the shutter lock member attaching portion of the housing of the magnetic disk cartridge.

### DESCRIPTION OF THE PREFERRED EMBODIMENTS

Hereinafter, a preferred embodiment of the present invention will be described in detail with reference to the drawings.

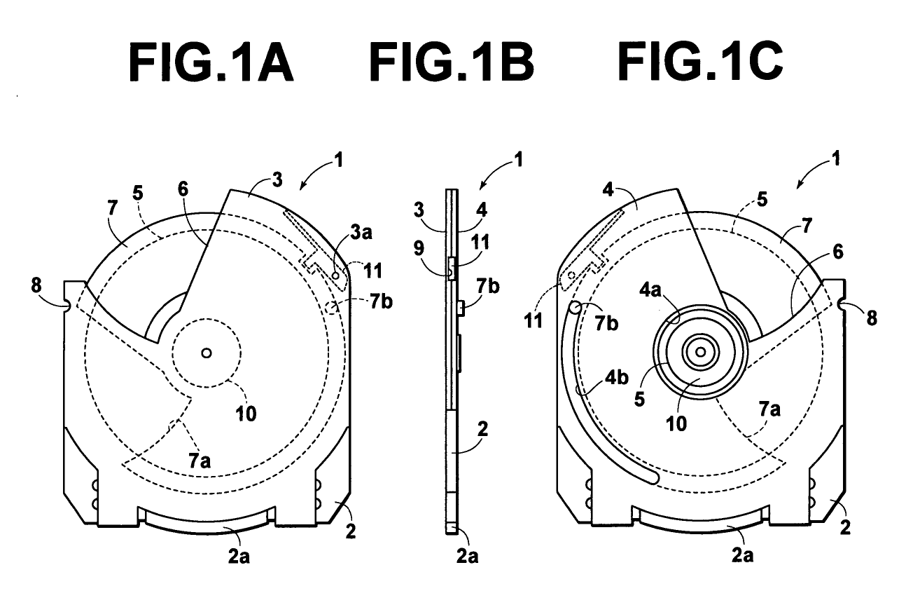

FIGS. 1A to 1C illustrate a very small magnetic disk cartridge called “clik!™” which is removably received within a PC card type drive unit in a push-and-pull manner.

FIG. 1A is a plan view, FIG. 1B is a right side view, and

FIG. 1C is a bottom view thereof.

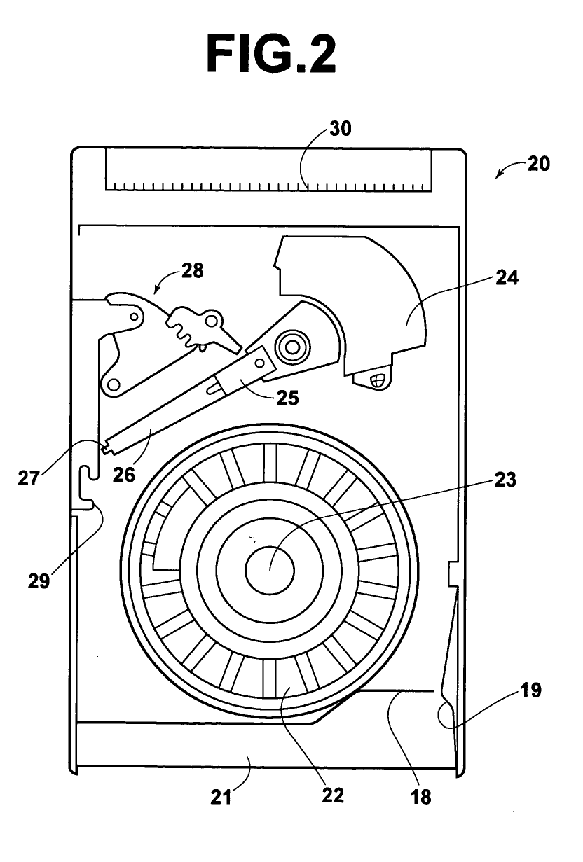

FIG. 2 is a plan view showing a body of the PC card type drive unit according to the invention. This drive unit comprises a drive unit body 20 (shown), and a metal upper lid (not shown) which is put on the body 20 and has substantially the same overhead contour as that of the body 20.

A magnetic disk cartridge 1 shown in FIG. 1 comprises a flat housing, and a 1.8 inch (45.7 mm) diameter magnetic disk 5 with a 40 MB storage capacity which is rotatably contained in the housing. The housing has a width of 50 mm, a depth of 55 mm and a thickness of 1.95 mm, and is constituted by a resin frame 2 including a push portion 2a, and upper and lower cartridge-shell halves 3 and 4 formed of thin metal sheets.

The aforementioned housing has a wedge-shaped opening 6 to allow a magnetic head 27 of the drive unit body 20 shown in FIG. 2 to access a surface of the magnetic disk 5, and a rotary shutter 7 used to open and close this opening 6. The rotary shutter 7 is spring-loaded towards its closing direction (in the counter-clockwise direction in FIG. 1A) by means of a small-diameter elongate coil spring (not shown) provided within the housing.

In the left end surface of the housing, a notch 8 to be engaged with a latching member 29 formed within the drive unit body 20 is provided to ensure positioning of the cartridge in the drive unit body 20. Meanwhile, in the right end surface of the housing, a small window 9 for exposing a pressing portion 12d of a shutter lock member 11 towards the exterior is provided to keep the rotary shutter 7 locked in the closed position. FIGS. 1A to 1C show the state in which the rotary shutter 7 is locked in the closed position.

When the magnetic disk cartridge 1 is inserted into the drive unit body 20, an unlocking member 19 provided on the drive unit body 20 pushes the pressing portion 12d of the shutter lock member 11 through the small window 9. This will cause the lock member 11 to be slightly rotated in the unlocking direction and thus the rotary shutter 7 is unlocked.

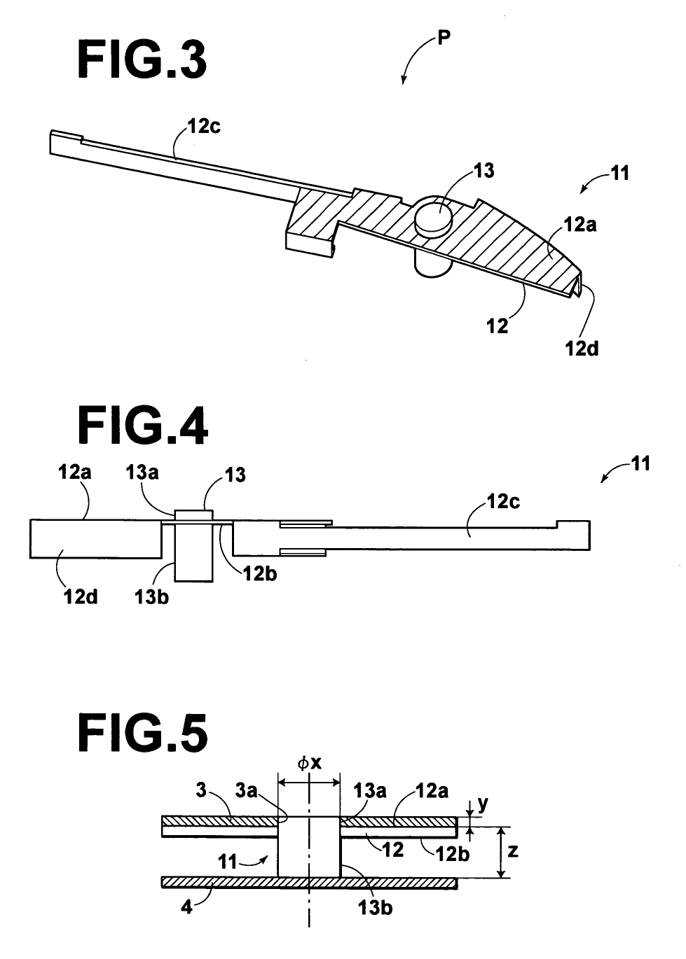

The construction of the shutter lock member 11 and the attachment mechanism of the shutter lock member 11 will now be explained in detail. FIG. 3 is a perspective view of a shutter lock member of the magnetic disk cartridge, FIG. 4 is a side view of the shutter lock member taken along arrow p in FIG. 3, and FIG. 5 is a sectional view of the shutter lock member attaching portion of the housing.

The shutter lock member 11 comprises a shutter lock body 12 and a rotary shaft 13 fixed to the shutter lock body 12. The shutter lock body 12 includes a sliding contact surface 12a (the hatched portion in FIG. 3) disposed on the upper surface thereof in sliding contact with the inner surface of the upper shell half 3.

The shutter lock body 12 further includes the pressing portion 12d adapted to be pushed by an unlocking member 19 (to be described later), and a resilient portion 12c for urging the shutter lock body 12 in the direction towards a predetermined position when this pressing portion 12d is pushed so that the shutter lock member 12 is rotated around the rotary shaft 13.

The rotary shaft 13 is constituted by a sliding-contact-surface-side protrusion 13a which extends from the sliding contact surface 12a of the shutter lock body 12, and an opposite-surface-side protrusion 13b which extends from the opposite lower surface 12b.

This shutter lock member 12 is, as shown in FIG. 5, configured such that the slide contact surface 12a is in sliding contact with the inner surface of the upper shell half 3 with the sliding-contact-surface-side protrusion 13a of the rotary shaft 13 being rotatably received within a protrusion receiving hole 3a formed in the upper shell half 3 and that the shutter lock member 12 is rotatably held between the upper and lower shell halves with the end of the opposite-surface-side protrusion 13b of the rotary shaft 13 being in slide contact with inner surface of the lower shell half 4.

In the shutter lock member 12, the diameter x of the sliding-contact-surface-side protrusion 13a is preferably sized to be approximately equal to the diameter of the protrusion receiving hole 3a with great precision in order to prevent the displacement of the center thereof with respect to the center of rotation when the sliding-contact-surface-side protrusion 13a is rotatably received within the protrusion receiving hole 3a.

Preferably, a distance y between the sliding contact surface 12a and the end of the sliding-contact-surface-side protrusion 13a is made smaller than the thickness of the upper shell half 3. Otherwise, the sliding-contact-surface-side protrusion 13a would project from the surface of the upper shell half 3.

Further, a distance z between the slide contact surface 12a and the end of the opposite-surface-side protrusion 13b is preferably made approximately equal to the distance from the inner surface of the upper shell half 3 to the inner surface of the lower shell half 4 with great precision in order to prevent the shutter lock member 12 from becoming disengaged while the shutter lock member 12 is being disposed between the upper and lower shell halves 3, 4.

By way of example, for the magnetic disk cartridge called “clik!™”, in the case that the diameter of the protrusion receiving hole is 2 mm, the proper construction can be obtained by setting the diameter x of the sliding-contact-surface-side protrusion to 2 mm, the distance y between the sliding contact surface to the end of the sliding-contact-surface-side protrusion to 0.2 mm, and the distance z between the sliding contact surface to the end of the other-surface-side protrusion to 1.55 mm.

Using the aforementioned configuration of the shutter lock member and housing eliminates the necessity of burring and caulking which have been conventionally required when attaching the shutter lock member, whereby the assembly process is facilitated and the cylindrical projection in communication with the interior of the housing becomes unnecessary, which also enables prevention of dust or other contaminants entering via the cylindrical projection.

The lower shell half 4 of the housing includes a circular opening 4a through which a rotary spindle 23 of the drive unit 20 couples with a center core 10 of the magnetic disk 5, and an arcuate groove 4b concentric with the rotary shutter 7. The rotary shutter 7 has a shutter knob 7b provided immovably thereon which projects from the aforementioned arcuate groove 4b and travels along this arcuate groove 4b, thereby opening and closing the rotary shutter 7.

The drive unit body 20 in FIG. 2 is a TYPE II PC card type drive unit, of which the dimensions are 53 mm wide, 85 mm deep, and 5 mm thick, and shown with a metal upper lid removed. The drive unit body 20 comprises a slot 21 into which the disk cartridge 1 is inserted, a spindle motor 22 having a spindle 23 which serves to magnetically attract the center core 10 of the magnetic disk 5, a head actuator 24, a swing arm 25, and a head suspension 26 supported by the swing arm 25. The head suspension 26 has at the tip thereof a magnetic head 27 which accesses the surface of the magnetic disk 5 during rotation for recording and/or reproducing information.

The drive unit body 20 further comprises a push-push type cartridge engagement and ejection mechanism 28 including a latching member 29 adapted to engage with a notch 8 of the magnetic disk cartridge 1, and an input/output interface 30 for interfacing to electronic equipment such as a digital camera, personal computer and the like to which the drive unit body 20 is mounted.

On the back and right side of the slot 21 of the drive unit body 20, an engaging wall 18, which extends laterally in a direction substantially perpendicular to the insertion direction of the magnetic disk cartridge 1, is formed as shutter opening means, and further an unlocking member 19 is provided which releases the rotary shutter 7 locked in its closed position upon insertion of the magnetic disk cartridge 1.

When the magnetic disk cartridge 1 is inserted into the slot 21 of the drive unit, the unlocking member 19 first pushes the pressing portion 12b of the shutter lock member 11 and then the shutter knob 7b engages with the engaging wall 18 under this state. Therefore, as the magnetic disk cartridge 1 is inserted, the shutter knob 7b is slid along the engaging wall 18, during which the rotary shutter 7 moves to its open position while compressing its urging coil spring. At the same time, the latching member 29 of the drive unit body 20 engages with the notch 8 of the magnetic disk cartridge 1, and thus the magnetic disk cartridge 1 is held in position within the drive unit body 20.

To remove the magnetic disk cartridge 1 from the drive unit, on the other hand, it is necessary to press the push portion 2a of the magnetic disk cartridges 1 such that the cartridge engagement and ejection mechanism 28 pushes out the magnetic disk cartridge 1. At this time, the initial velocity for ejection is ensured by the compressed coil spring for urging the rotary shutter. The rotary shutter 7 is rotated to its closed position by the urging force of the aforementioned coil spring as the magnetic disk cartridge 1 is pulled out, and finally locked by the shutter lock member 11.

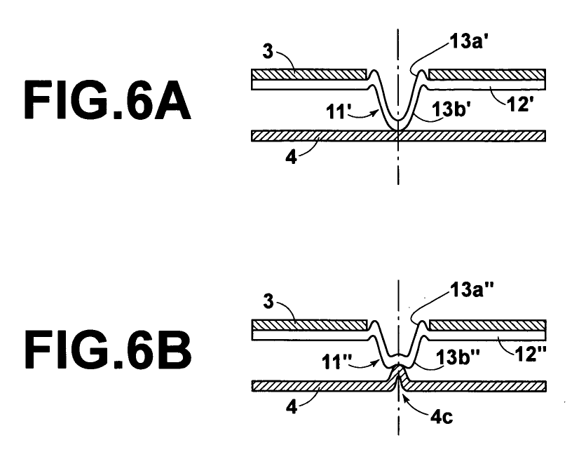

While the invention has been described in terms of a preferred embodiment, it should be understood that the shutter lock member is not limited to the disclosed embodiment. As shown in FIG. 6A, a shutter lock body 12′ may be integrally formed with a sliding-contact-surface-side protrusion 13a′ and an opposite-surface-side protrusion 13b′ by shaping the sliding-contact-surface-side protrusion 13a′ and opposite-surface-side protrusion 13b′ by deep drawing.

In such an embodiment, as shown in FIG. 6B, the distance from the end of a sliding-contact-surface-side protrusion 13a″ to the end of an opposite-surface-side protrusion 13b″ can be reduced by forming a projection 4c on a lower shell half 4′ by deep drawing or the like, and therefore if the shutter lock body 12″ is produced by deep drawing, it is facilitated.

What is claimed is:

1. A magnetic disk cartridge: comprising a flat housing constituted by upper and lower shell halves; and a magnetic disk as a recording medium which is rotatably accommodated within the housing, the housing including an opening to allow a recording/reproducing head of a drive unit to access a surface of the magnetic disk, a rotary shutter used to open and close the opening, and a shutter lock member for locking the rotary shutter at its closed position,
wherein the shutter lock member is constituted by a shutter lock body having a sliding contact surface provided on the upper or lower surface of the shutter lock member in sliding contact with the inner surface of either one of the upper and lower shell halves, a sliding-contact-surface-side protrusion formed on the one of the upper or lower surface of the shutter lock body, and an opposite-surface-side protrusion formed on the other of the upper or lower surface of the shutter lock body;
wherein one of the upper and lower shell halves includes a protrusion receiving hole having a diameter substantially same as that of the sliding-contact-surface-side protrusion; and
wherein the shutter lock member is rotatably disposed between the upper and lower shell halves while the sliding contact surface of the shutter lock member is in sliding contact with the inner surface of the one of the shell halves with the sliding-contact-surface-side protrusion being received within the protrusion receiving hole, and while the end of the opposite-surface-side protrusion is in sliding contact with the inner surface of the other shell half.

2. A magnetic disk cartridge according to claim 1, wherein the shutter lock member is formed integrally with the sliding-contact-surface-side protrusion and the opposite-surface-side protrusion.

3. A magnetic disk cartridge according to claim 2,
wherein the shutter lock member has a recess, which is concave relative to the sliding-contact-surface-side protrusion, at the distal end of the opposite-surface-side protrusion; and
wherein the other shell half has a projection which matingly engages with the recess.
